(19) United States
(12) Patent Application Publication
(10) Pub. No.: US 2017/0227082 A1
(43) Pub. Date: Aug. 10, 2017

(54) FLOW ADJUSTMENT AND OIL PATH SEPARATION STRUCTURE OF SHOCK ABSORBER

(71) Applicant: KIND SHOCK HI-TECH CO., LTD., TAINAN CITY (TW)

(72) Inventor: JUNG YU HSU, TAINAN CITY (TW)

(21) Appl. No.: 15/015,807

(22) Filed: Feb. 4, 2016

(51) Int. Cl. F16F 9/44; F16F 9/18

(52) U.S. Cl. CPC F16F 9/44; F16F 9/185

(57) ABSTRACT

A flow adjustment and oil path separation structure of a shock absorber includes inner and outer tubes sheathed and linearly contracted and extended with respect to each other and having a base tube module installed in the inner tube and including a first component and a second component sheathed on each other. A primary oil chamber is formed in the first component. A secondary oil chamber is formed between the first and second components. An oil path separation module includes an oil path separator seat with an ON/OFF installing slot, a primary channel, a secondary channel group, a first adjusting hole and a communication channel. A first adjustment module is installed at the first adjusting hole for adjusting the amount of hydraulic oil in the first adjusting hole. An ON/OFF switch module is installed in the ON/OFF installing slot for switching a flow ON/OFF status of the secondary channel group.

### FIELD OF THE INVENTION

The present invention relates to a flow adjustment structure of a hydraulic shock absorber, and more particularly to the flow adjustment structure that uses an oil path separator seat for the oil path diversion of each oil chamber and combines with a structure having an adjustment module to adjust a damping ratio during shock absorption.

### BACKGROUND OF THE INVENTION

In general, a shock absorber is primarily provided for receiving and stopping an impact force exerted on a mechanism to provide a buffering function for offsetting the force, and the shock absorber is used extensively in different areas such as machine, equipments, transportation means, furniture, molds or tools, and particularly in the transportation means. The impact force produced from road conditions and transmitted to wheels and a vehicle body of the transportation means is absorbed by the shock absorber or a suspension device to provide a comfortable ride of passengers.

In bicycles, the shock absorber is usually installed at a front fork, a seat post or a rear fork, and primarily provided for buffering the impact force coming from the ground and transmitted to the front wheel and the front fork. The shock absorber installed in the seat post is provided for buffering the impact force transmitted from a main bike frame to the seat post, and the absorber installed between the rear fork and the main bike frame is provided for buffering the impact force transmitted from the ground to the rear wheel.

The front fork shock absorber of a bicycle is mainly divided into a “mechanical”, “hydraulic”, or “oil and gas hybrid” shock absorber, wherein the mechanical front fork shock absorber refers to a component capable of producing a damping force in its structure and using an elastic member to buffer the impact force. One of such front fork shock absorber known to applicant comes with an oil chamber in the front fork and filled with a hydraulic oil that flows appropriately in the structure to provide the buffering effect based on the hydraulic principle. Another pneumatic front fork shock absorber comes with an oil chamber and an air chamber designed in the structure, and the property of a gas being compressible is used for buffering the impact force. Other shock absorbers such as “hydraulic and pneumatic” and “mechanical and hydraulic” shock absorbers are applied in a “hybrid” front fork shock absorber structure.

The hydraulic bicycle front fork shock absorber is not just designed to provide the basic buffering effect only, but it is also developed into a shock absorber with lockable and unlockable damping since a rider needs more effort to overcome the shock and no longer needs the function in a plan road condition, so that users may enable the shock absorbing function according to requirements. Some manufacturers further install an adjusting device in the bicycle front fork shock absorber, so that users may adjust the damping ratio to produce different levels of shock absorption. Such front fork shock absorber with a damping adjusting effect known to applicant comprises an inner tube which may be passed and installed into an end of an outer tube, and a piston having a sliding hole is installed at the inner tube that is installed at an end of the outer tube. A hollow tube with an end is fixed to the interior of the outer tube, and a through hole with a different hole diameter is formed inside the other end. A lower oil hole is formed radially on a wall of an end with a large hole diameter and communicates with the through hole. The end further has an adjusting valve disposed in the inner tube. An ejecting rod is passed through the adjusting valve and combined with the hollow tube, and an oil hole is formed in and penetrated through the ejecting rod. A control rod is installed in the hollow tube and has upper and lower cones formed at both ends of the control rod respectively. A circular portion is formed at the middle section of the control rod and disposed in a hole having a larger hole diameter and formed on the hollow rod. The upper cone has an elastic member installed to an outer side of the upper cone and disposed on an end surface of the circular portion and the ejecting rod. An adjusting member is installed onto the outer tube and disposed opposite to the lower cone. The adjusting member has a knob and an actuating member coupled to the knob. An end surface of the actuating member is formed into a conical top pushing surface. The top pushing surface and the lower cone are contacted and abutted against each other.

Another front fork shock absorber capable of adjusting the damping ratio known to application comprises an inner tube and an outer tube. A hollow piston is installed at an end of the inner tube. An adjusting tube is installed in the outer tube and the other end of the adjusting tube penetrates through the piston. The adjusting tube includes a hollow tube and a control rod is disposed inside the hollow tube. The hollow tube sequentially includes a spring, a washer, an adjusting valve with a side hole formed along the axial direction and disposed at an end of the inner tube and the adjusting valve. The inner tube has an upper and lower oil chambers formed therein. An ejecting rod is installed inside the oil hole and penetrates through each component and is fixed to a top end of the hollow tube. The washer is disposed at a side hole formed at an end opposite to the piston, and the hollow tube has an oil hole formed inside the lower oil chamber and communicates with the lower oil hole. The other end of the hollow tube penetrates through the outer tube and is fixed to the outer tube. A control rod is installed in the hollow tube, and has a cone formed at an end opposite to the lower oil hole. A gap is formed between the two.

In the aforementioned two structures, both have a shock absorber capable of adjusting damping and an adjusting knob installed under a front fork. The former primarily turns and drives the control rod by the top pushing surface in order to control the size of the oil hole and to achieve the effects of changing the flow rate of the hydraulic oil flow rate and to adjust the buffering level. The latter turns the lower knob to drive the control rod to produce a linear displacement and change the size of the oil hole, so as to achieve the effect of adjusting the buffer damping. However, such damping adjustment is applicable for a shock absorber in the buffering status only. If the shock absorber is switched to a shock absorbing and buffering status, the rider's pedaling force is consumed by the shock absorber although the impact force coming from the ground can be absorbed, so that the rider has to ride with more effort. If the damping ratio of the shock absorber is adjusted to a smaller ratio in order to reduce the force consuming, the buffering effect will be lower. If the damping ratio is adjusted to a larger ratio to increase the force consuming, the buffering effect will be higher. Therefore, the damping ratio may be adjusted by the rider according to requirements, road conditions, and personal preference.

However, the aforementioned conventional shock absorber capable of adjusting damping includes a component provided for a rider to turn and adjust the damping ratio, and such component is installed at a position under the front fork and proximate to the center position of the wheels, so that when the rider needs to make an adjustment of the damping ratio, the rider has to get off from the bike frame, park the bike and squat down before making the adjustment, and then stand up and get into the bike frame. Obviously, the adjustment requiring the foregoing steps is very inconvenient. In addition, the conventional structure comes with a simple and direct hydraulic oil flow path, so that if the impact force is large, then the flow of the hydraulic oil will encounter less resistance and will produce a greater flow rate and a larger force on the related components The components may be collided with each other or damaged easily to result in a shorter service life. On the other hand, the direct oil path produces a greater flow rate, so that the motions such as absorbing force, compressing, and rebounding will be quicker, and the rider may lose balance when the rider fails to respond immediately. Therefore, the inventor of the present invention provides a shock absorber capable of adjusting the damping ratio to achieve the effects of reducing the chance of damaging the components, improving the safety of the ride, and solving the problem of inconveniently making adjustments.

### SUMMARY OF THE INVENTION

In view of the aforementioned problems, the present invention provides a flow adjustment and oil path separation structure of a shock absorber, and the structure is installed between an inner tube and an outer tube sheathed and linearly contracted and extended with respect to each other and comprises: a base tube module installed in the inner tube and including a first component and a second component sheathed on each other, a primary oil chamber formed in the first component, and a secondary oil chamber formed between the first and second components; an oil path separation module, including an oil path separator seat with an ON/OFF installing slot concavely formed at a predetermined position and communicated with the secondary oil chamber, and the oil path separator seat having a primary channel communicated with the primary oil chamber and a secondary channel group communicated with the secondary oil chamber, and an end of the secondary channel being communicated with the primary channel; an adjustment module, having a first adjusting hole, and an end communicated with the secondary channel group, and a communication channel being used for communicating with the ON/OFF installing slot and the secondary channel group, and a first adjustment module, being installed in the first adjusting hole, for adjusting the amount of a hydraulic oil in the first adjusting hole; an ON/OFF switch module, installed in the ON/OFF installing slot and provided for switching the flow ON/OFF status of the secondary channel group. When the ON/OFF switch module is switched to an ON status, the primary channel and secondary channel group are situated in a shock absorbing status. When an impact pressure is encountered, the hydraulic oil flows from the primary oil chamber through the primary channel and sequentially passes through the secondary channel group, the communication channel, and the ON/OFF installing module before flowing to the secondary oil chamber to define a shock absorbing and buffering status. With the aforementioned components, the oil path separator seat is used to provide a bypass flow structure between the primary oil chamber and the secondary oil chamber. The invention further integrates the design of an adjustment module to provide a higher setting of the damping ratio and increase the range of the damping ratio, and also achieves the effects of lowering the chance of colliding and damaging related components when an impact force is encountered, extending the service life of components, reducing the compression and rebounce in shock absorption, improving the safety of riding, and provides a convenient way for the rider to rotate the knob and make adjustment by designing the knob at the top of the front fork. Obviously, the present invention is very convenient and practical.

Therefore, it is a primary objective of the present invention to provide a flow adjustment and oil path separation structure of a shock absorber, and the structure comprises an oil path separator seat, so that a bypass flow path exists between a primary oil chamber and a secondary oil chamber, and the structural design of an adjustment module is used to provide a higher setting and a greater range of the damping ratio.

A secondary objective of the present invention is to provide a flow adjustment and oil path separation structure of a shock absorber, wherein an oil path separator seat is provided for separating two oil chambers and the oil path of each channel, and the structure is applicable for the design having two oil chambers arranged parallel to each other, so that such structure also has the function of separating a plurality of channels, and the structure is applicable for more than one set of damping adjustment modules.

Another objective of the present invention is to provide a flow adjustment and oil path separation structure of a shock absorber, wherein at least one flow adjustment module is installed at a predetermined position of the oil path, and an oil path separator seat with the design of a bypass flow path, so as to achieve the effects of increasing the damping ratio conveniently when the shock absorber is situated in an ON status, reducing the chance of colliding or damaging related components to improve the service life of the components when impact forces are received, as well as reducing the compression and rebounce to improve the safety of the ride.

A further objective of the present invention is to provide a flow adjustment and oil path separation structure of a shock absorber, wherein the damping adjusting knob and buffering ON/OFF button are installed at the top of the primary oil chamber and the secondary oil chamber, so that when the whole shock absorbing structure is used at the front fork, each knob is situated at the top position of the front fork to provide a more convenient way for the rider to rotate the knob to change the damping ratio.

### BRIEF DESCRIPTION OF THE DRAWINGS

FIG. 1 is a perspective view of an oil path separator seat in accordance with a preferred embodiment of the present invention;

FIG. 2 is a planar view of an oil path separator seat in accordance with a preferred embodiment of the present invention;

FIG. 3 is a first cross-sectional view of an oil path separator seat in accordance with a preferred embodiment of the present invention;

FIG. 4 is a second cross-sectional view of an oil path separator seat in accordance with a preferred embodiment of the present invention;

FIG. 5 is a third cross-sectional view of an oil path separator seat in accordance with a preferred embodiment of the present invention;

FIG. 6 is a fourth cross-sectional view of an oil path separator seat in accordance with a preferred embodiment of the present invention;

FIG. 7 is a fifth cross-sectional view of an oil path separator seat in accordance with a preferred embodiment of the present invention;

FIG. 8 is a first exploded view of a preferred embodiment of the present invention;

FIG. 9 is a second exploded view of a preferred embodiment of the present invention;

FIG. 10 is a third exploded view of a preferred embodiment of the present invention;

FIG. 11 is a planar view of a preferred embodiment of the present invention;

FIG. 12 is a first cross-sectional view of a preferred embodiment of the present invention;

FIG. 13 is a second cross-sectional view of a preferred embodiment of the present invention;

FIG. 14 is a third cross-sectional view of a preferred embodiment of the present invention;

FIG. 15 is a first partial blowup view of a preferred embodiment of the present invention;

FIG. 16 is a fourth cross-sectional view of a preferred embodiment of the present invention;

FIG. 17 is a fourth cross-sectional view of a preferred embodiment of the present invention;

FIG. 18 is a schematic view showing an operating status of a preferred embodiment of the present invention;

FIG. 19 is a second partial blowup view of a preferred embodiment of the present invention; and

FIG. 20 is an exploded view of another preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

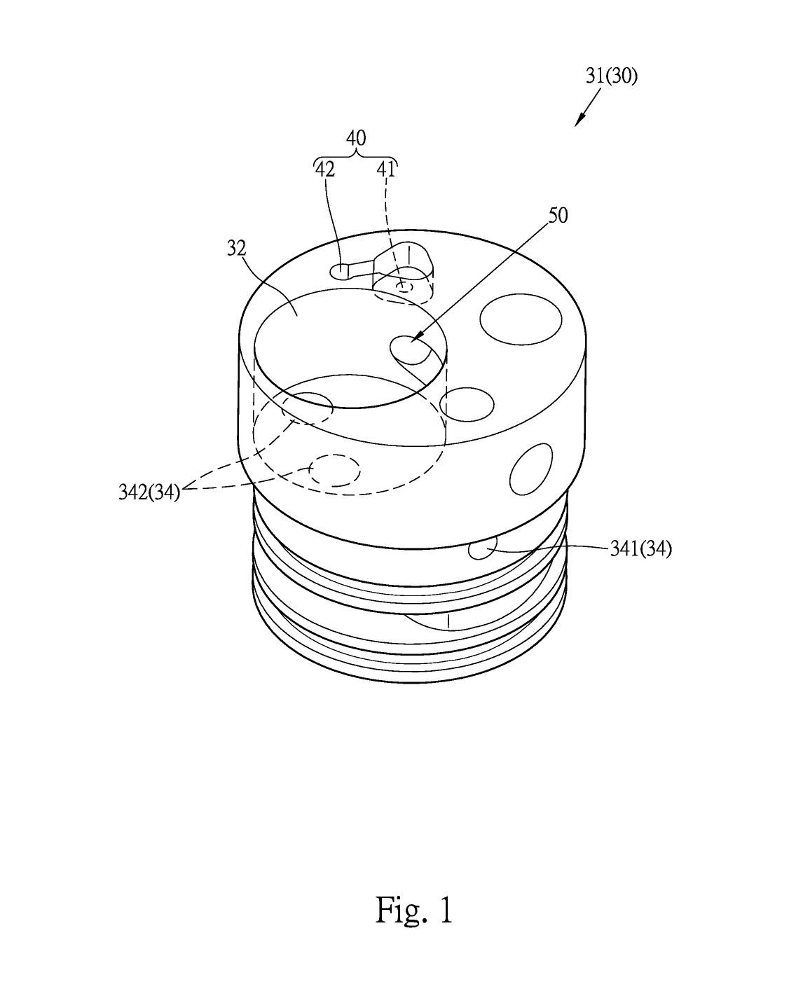

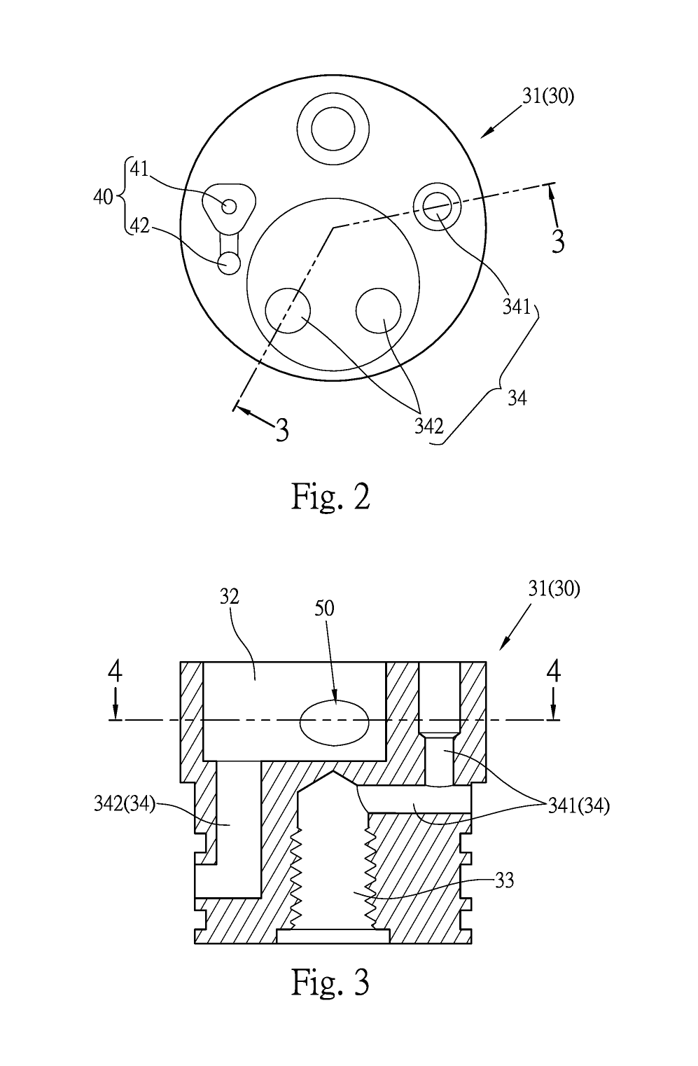

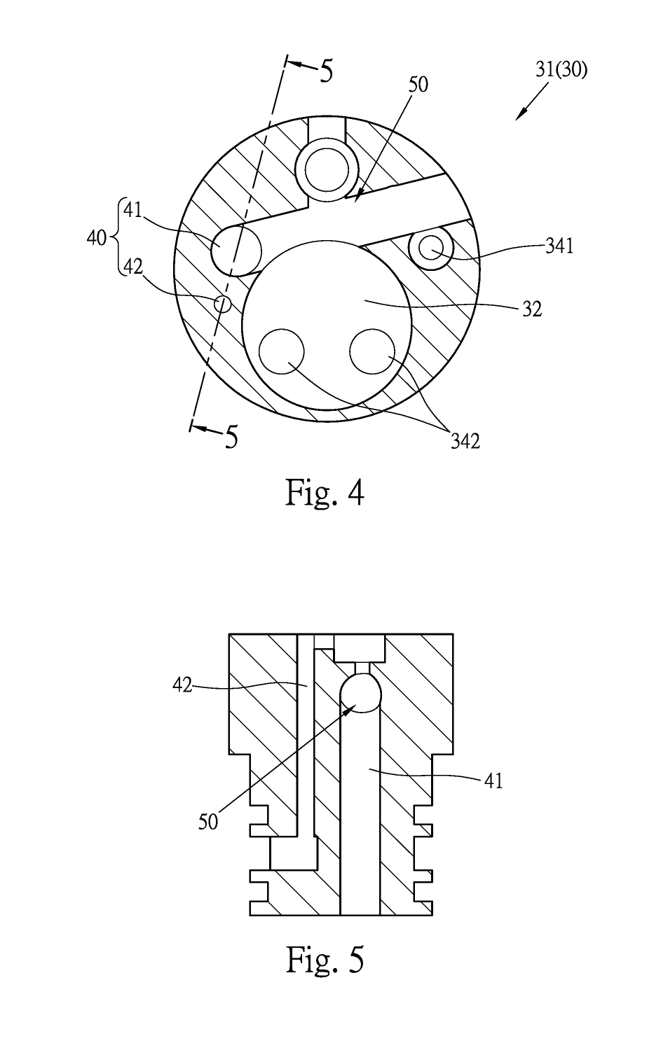

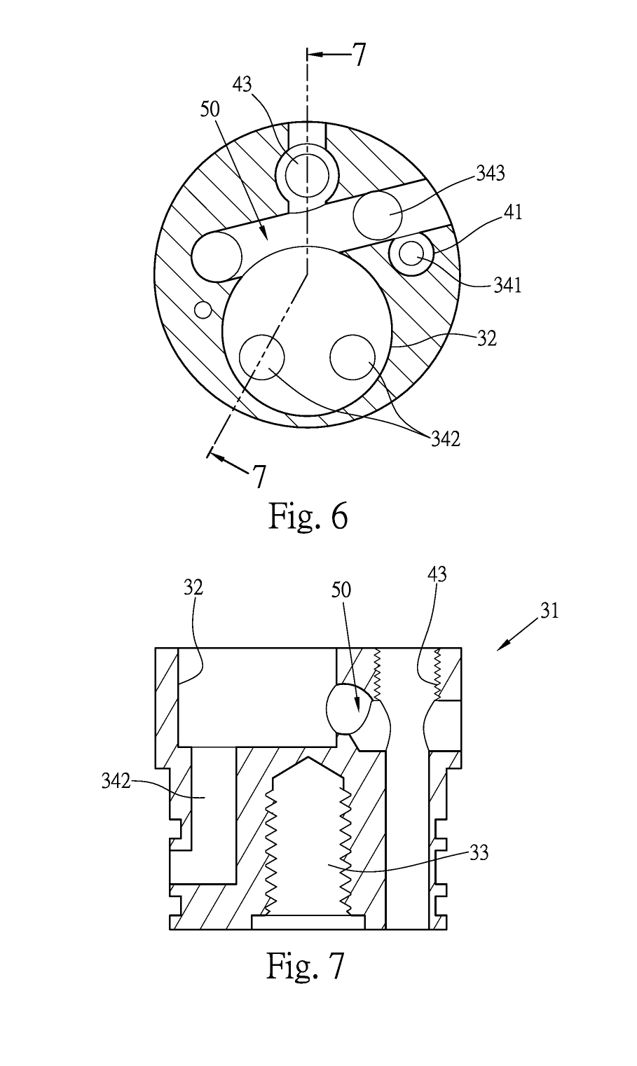

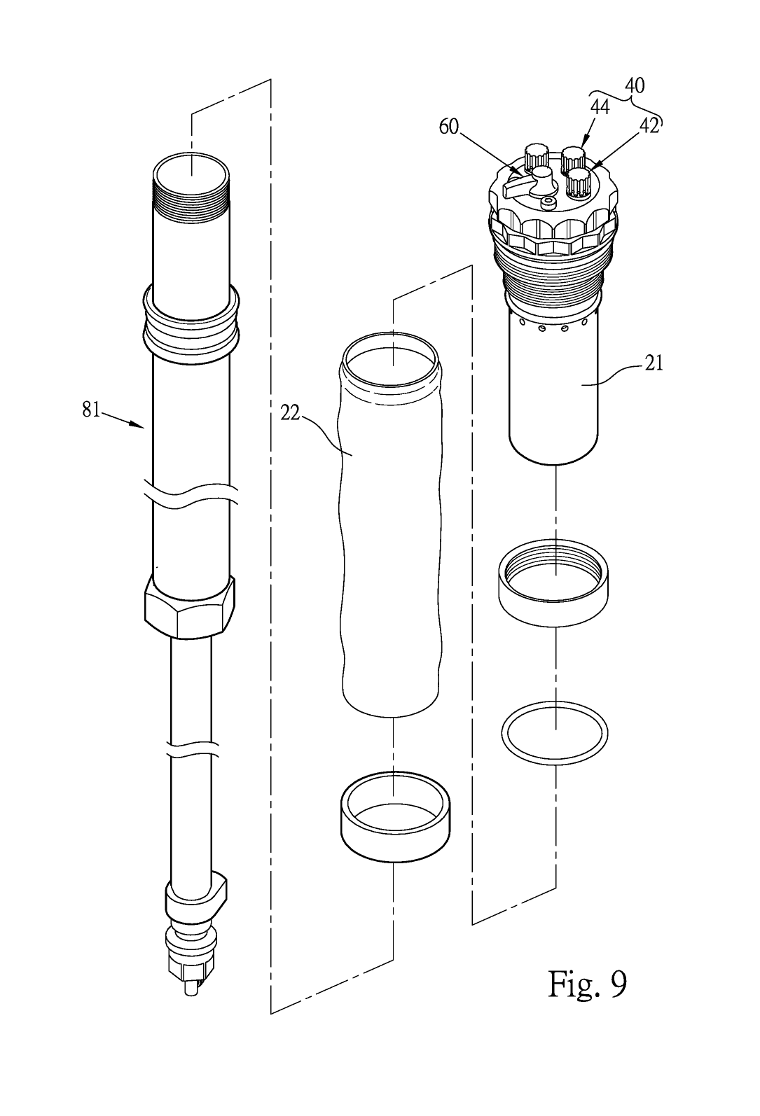

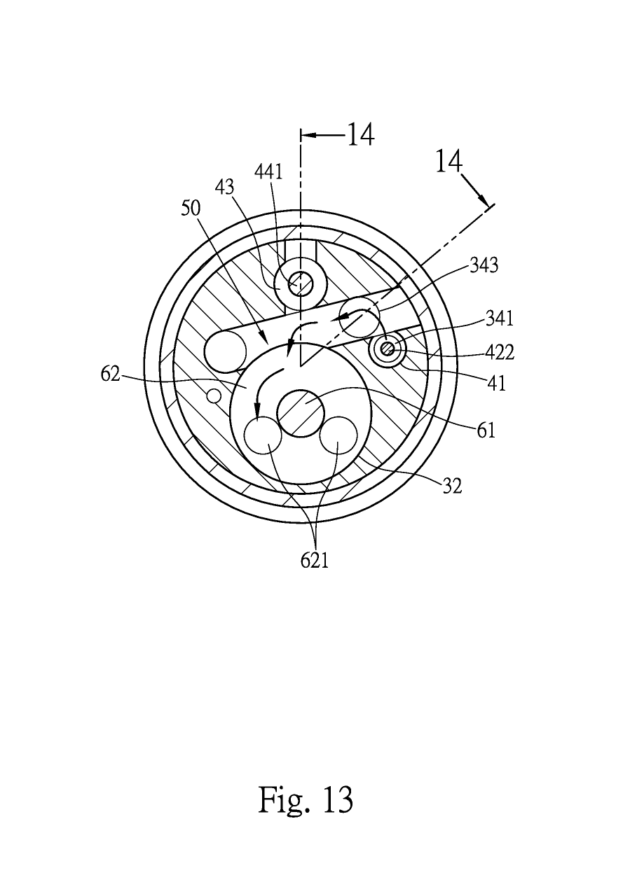

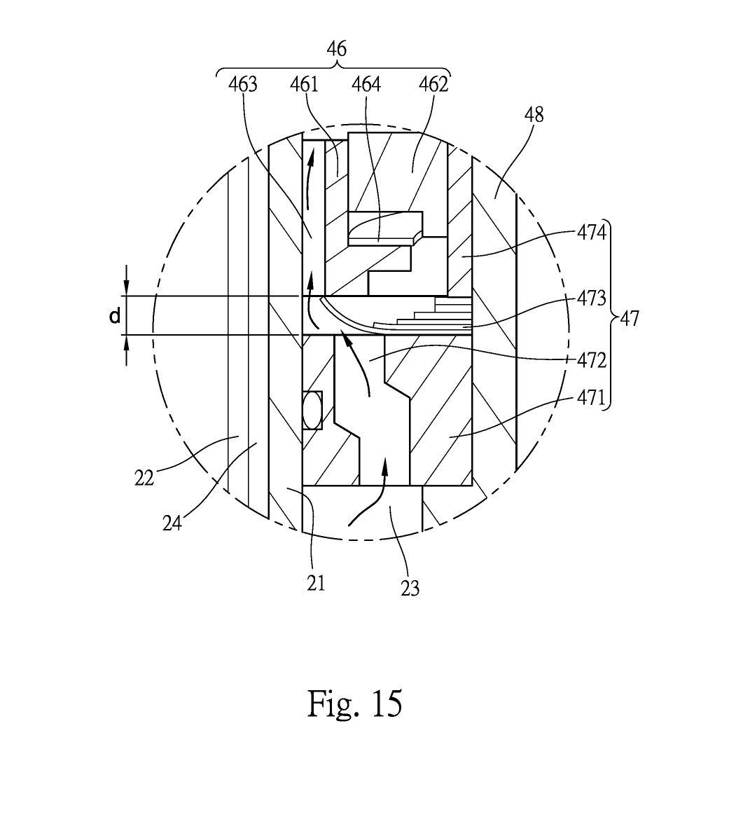

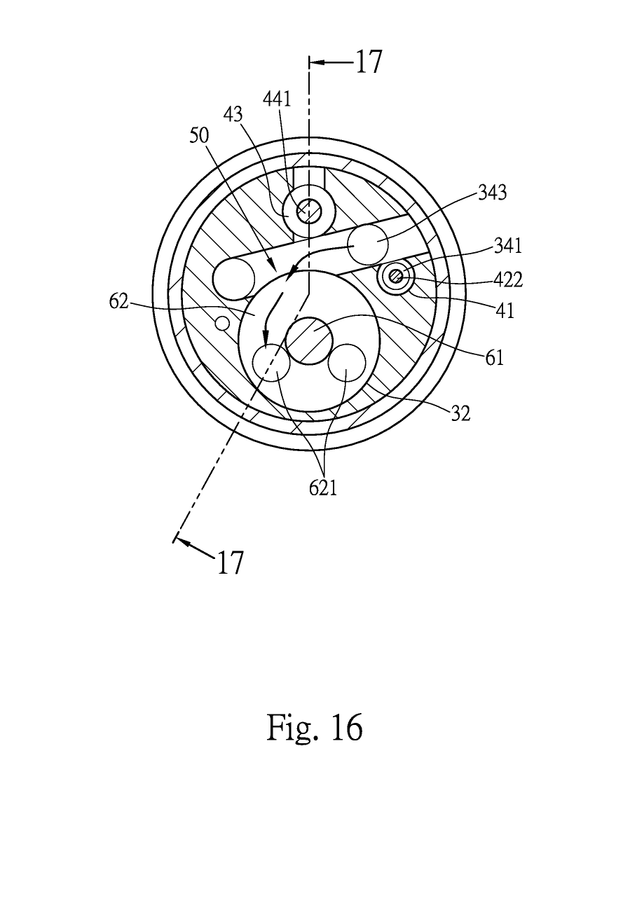

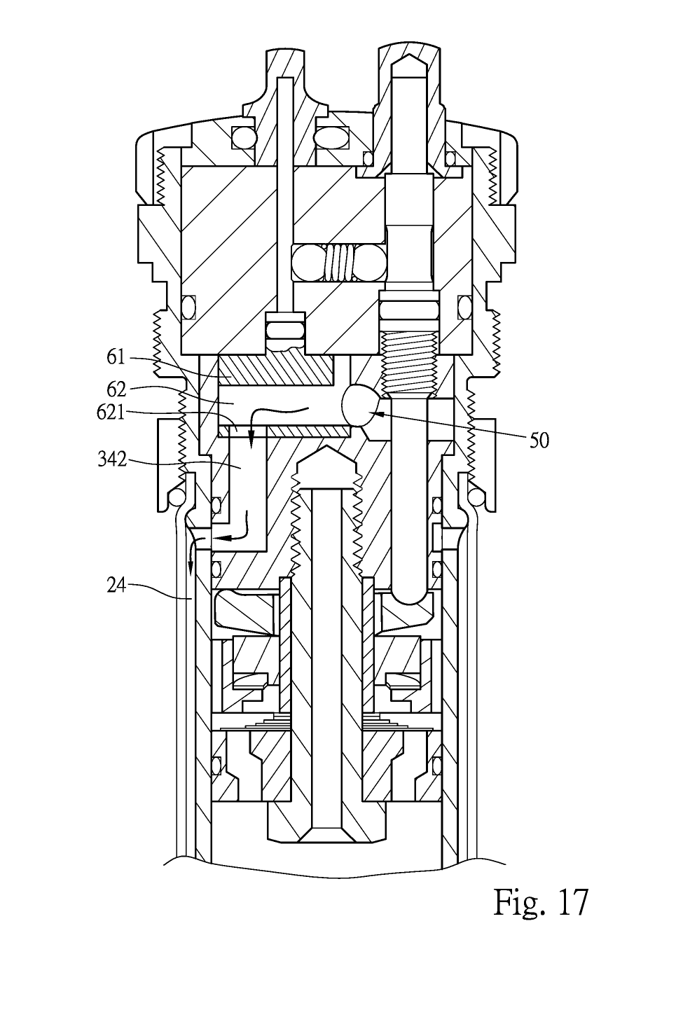

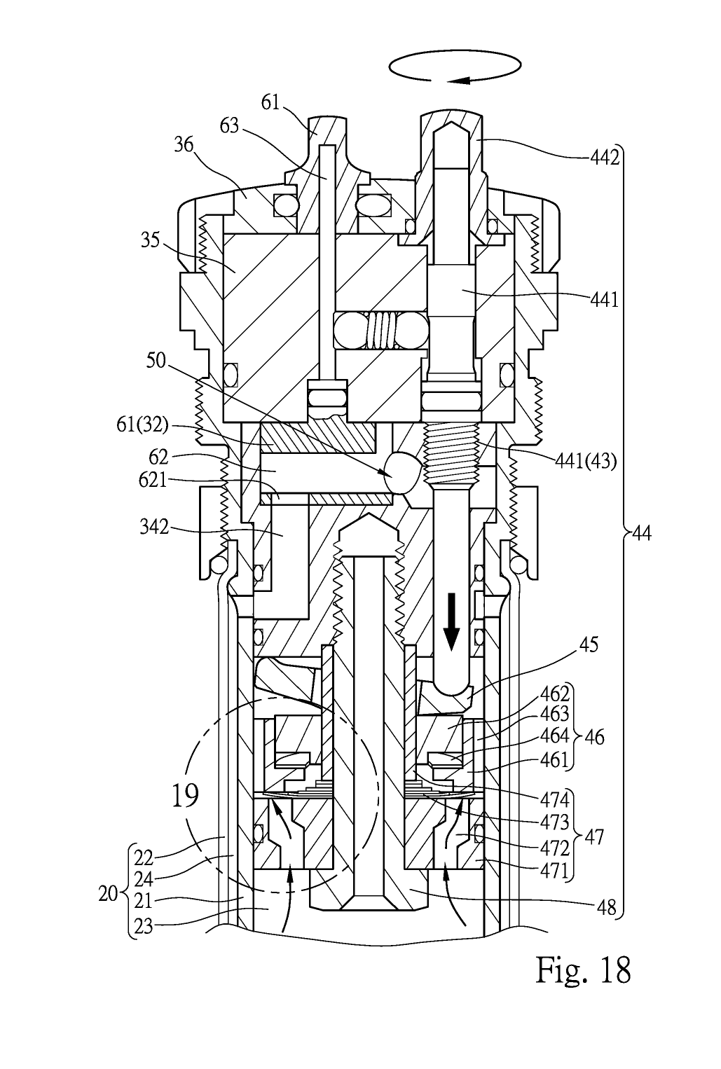

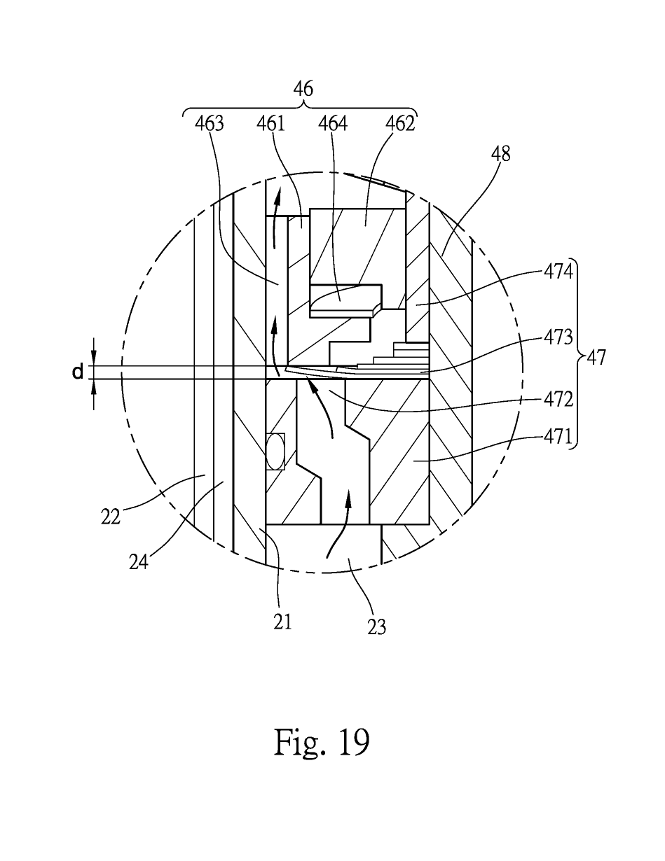

With reference to FIGS. 1 to 19 for a flow adjustment and oil path separation structure of a shock absorber in accordance with the present invention, the flow adjustment and oil path separation structure is applied to a front fork (81) of a bicycle, and the structure comprises: a shock absorption tube module (10), and a base tube module (20), an oil path separation module (30), an adjustment module (40), a communication channel (50), an ON/OFF switch module (60) and at least one speed adjustment module (70) installed in the shock absorption tube module (10).

The shock absorption tube module (10) is applied to the inner tube and the outer tube of the front fork of a bicycle, and includes an inner tube (11) and an outer tube (12) sheathed and linearly contracted and extended with respect to each other.

The base tube module (20) is installed at a predetermined position in the inner tube (11) and comprises: a first component (21) and a second component (22) sheathed on each other; a primary oil chamber (23) formed in the first component (21); and a secondary oil chamber (24) formed between the first and second components (21)(22), wherein the first component (21) is a tube, and the second component (22) is an oil bag made of an elastic material.

The oil path separation module (30) comprises: an oil path separator seat (31) in form of a seat; an ON/OFF installing slot (32), being a slot formed at a predetermined position of the oil path separator seat (31) for providing a position for installing the ON/OFF switch module (60); a primary channel (33), disposed at a predetermined position in the oil path separator seat (31) and communicated with the primary oil chamber (23); a secondary channel group (34), disposed at a predetermined position in the oil path separator seat (31) and including a first secondary channel (341) and a second secondary channel (342), and the first secondary channel (341) having an end communicated with the primary channel (33) and the other end communicated with a secondary oil chamber (24); and the second secondary channel (342) having an end communicated with the ON/OFF installing slot (32) and the other end communicated with the secondary oil chamber (24); a third secondary channel (343), installed at a predetermined position in the oil path separator seat (31) and having an end communicated with the communication channel (50) and the other end communicated with the primary oil chamber (23); a mounting seat (35), installed at the top of the oil path separator seat (31) for installing the ON/OFF switch module (60) and the adjustment module (70) therein; a top cover (36), installed at the top of the mounting seat (35) for partially installing the ON/OFF switch module (50) and the adjustment module (70) therein and partially exposing them therefrom.

The adjustment module (40) has a first adjusting hole (41) and an end communicated with the secondary channel group (34) and communicated with the ON/OFF installing slot (32) and the secondary channel group (34) through a communication channel (50); a first adjustment module (42), installed in the first adjusting hole (41), for adjusting the amount of hydraulic oil in the first adjusting hole (41); a second adjusting hole (43), being a penetrating hole formed at a predetermined position of the oil path separator seat (31), for providing a position for installing a second adjustment module (44), and the second adjusting hole (42) having an end communicated with the primary oil chamber (23), and the second adjustment module (44) being provided for adjusting the amount of hydraulic oil in the second adjusting hole (43); wherein the first adjustment module (42) comprises an adjusting rod (421) with an end disposed in the oil path separator seat (31) and being a predetermined position of the flow path of the hydraulic oil between the secondary channels (34) and the communication channel (50) and the other end extended towards the exterior of the oil path separator seat (31), and the adjusting rod (421) being capable of performing a linear displacement in the oil path separator seat (31); the adjusting rod (421) having an adjusting portion (422) which is in a conical shape and formed at an end of the flow path of the hydraulic oil; a knob (423) installed at a position of the adjusting rod (421) exposed from the oil path separator seat (31) and capable of driving the adjusting rod (421) to rotate synchronously, while driving the adjusting rod (421) to perform a linear displacement in the oil path separator seat (31) and change the position of the adjusting portion (422) of the adjusting rod (421) to adjust the amount and flow rate of the hydraulic oil assign through the flow path between the secondary channels (34) and the communication channel (50).

The second adjustment module (44) comprises an adjusting rod (441) passed through the second adjusting hole (43) and having an end extended into the primary oil chamber (23) and coupled to an abutting member (45) and the other end extended towards the exterior of the oil path separator seat (31); a knob (442) installed at a position of the adjusting rod (441) exposed from the oil path separator seat (31) and capable of driving the adjusting rod (441) to rotate synchronously, while driving the adjusting rod (441) to linearly displace in the oil path separator seat (31) to press the abutting member (45) to produce a movement; wherein the second adjustment module (44) comprises a floating component (46) and an adjustment module (47) installed in the primary oil chamber (23); the adjustment module (47) is provided for circulating the hydraulic oil and using a positioning tube (48) to sequentially pass the adjustment module (47), the floating component (46) and the abutting member (45) and then fixing them onto the oil path separator seat (31); the floating component (46) is situated at a linear moving status in the primary oil chamber (23); the adjusting rod (441) and the abutting member (45) are synchronously and linearly moved and attached to the floating component (46) for performing a synchronous displacement, so as to change the distance between the floating component (46) and the adjustment module (47) and adjust the amount and flow rate of hydraulic oil stored in the primary oil chamber (23) and passing through the adjustment module (47).

The floating component (46) may be situated at a floating status of a linear displacement and comprises a first floating member (461) and a second floating member (462) sheathed on each other, and the first floating member (461) is abutted against and coupled to the abutting member (45); the second floating member (462) is disposed outside the first floating member (461), and the second floating member (462) has a plurality of circulating portions (463) disposed at predetermined positions respectively and provided for circulating the hydraulic oil; and a reed (464) is installed between the first and second floating members (461) (462) for providing a compressible elastic space between the first and second floating members (461)(462).

The adjustment module (47) comprises: an adjusting base (471); a plurality of penetrating holes (472) formed thereon and provided for circulating a hydraulic oil; a regulating spring member (473), which is a circular laminated spring, an elastic plate, or a reed, installed onto the adjusting base (471) and capable of effectively opening and closing each of the penetrating holes (472), and the regulating spring member (473) being capable of changing the distance between the penetrating holes (472) according to the pressure of the hydraulic oil; an abutting ring (474), being in the shape of a circular base disposed outside the positioning tube (48), and having an edge abutted against and fixed to the oil path separator seat (31) and the other side abutted at the central position of the regulating spring member (473).

The communication channel (50) is disposed at a predetermined position in the oil path separator seat (31) and communicated with the first secondary channel (341), the ON/OFF installing slot (32), the third secondary channel (343) and the second adjusting hole (43).

The ON/OFF switch module (60) is installed in the ON/OFF installing slot (32) and provided for switching the flow ON/OFF status of the secondary channel group (34). If the ON/OFF switch module (32) is switched to ON, so that the primary channel (33) and the secondary channel group (34) are situated at a shock absorbing status, and the hydraulic oil will flow from the primary oil chamber (23) through the primary channel (33) and then sequentially pass through the secondary channel group (34), the communication channel (50), and the ON/OFF installing module (60) to the secondary oil chamber (24) to define a shock absorbing and buffering status when an impact pressure is encountered; the ON/OFF switch module (60) includes a switch seat (61) installed at a predetermined position in the ON/OFF installing slot (32) and another predetermined position of the ON/OFF switch module (60) passing through the oil path separator seat (31) and the mounting seat (35), and having an end extended towards the exterior of the top cover (36); the switch seat (61) includes a diversion channel (62) connected to the secondary oil chamber (24) and capable of guiding the hydraulic oil stored in the communication channel (50) to flow to the secondary oil chamber (24), and the switch seat (61) being rotated to a predetermined angle to switch and turn on or off the diversion channel (62), such that the hydraulic oil circulating in the primary oil chambers (23), the secondary oil chamber (24) and the oil path separation module (31) is situated in a buffering locked status or a buffering shock absorbing status; an ON/OFF switch button (63), disposed at a position of the switch seat (61) exposed from the top cover (36) and provided for driving the switch seat (61) to rotate synchronously and switch the ON status of the diversion channel (62); the diversion channel (62), including two diversion holes (621) formed on the switch seat (61) and the switch seat (61) being rotated to a predetermined angle to align the diversion hole (621) with the second secondary channel (342) and flow the, hydraulic oil between the primary oil chambers (23), the secondary oil chamber (24) and the oil path separator seat (31) to define an buffer ON status; or the switch seat (61) being rotated to a predetermined angle to align the diversion hole (621) alternately with the second secondary channel (342) to prevent the hydraulic oil to flow between the primary oil chambers (23), the secondary oil chamber (24) and the oil path separator seat (31) to define a buffer locked status.

Each speed adjustment module (70) is installed in the mounting seat (35) and abutted at a predetermined position in a radial direction of the adjusting rod (421)(441) and includes at least one sectioned portion (71)(72) in a planar form disposed around each adjusting rod (421)(421); each speed adjustment module (70) has two steel balls (73)(74) and an elastic member (75)(76) coupled to each other and installed in the mounting seat (35), wherein one of the steel balls (73)(74) is abutted and coupled to the sectioned portion (71)(72) effectively.

With the aforementioned components, the oil path separator seat (31) provides a bypass flow structure between the primary oil chambers (23) and the secondary oil chamber (24), and design of the adjustment module (40) is adopted to provide a higher setting of the damping ratio and increase the range of the damping ratio. In the meantime, when an impact force is encountered, the chance of colliding or damaging related components is reduced to achieve the effects of extending service life, and reducing the compression and rebounce during the buffering process, improving the safety of riding, and the knobs (423) (442) and the ON/OFF switch button (63) are situated at the top of the bicycle front fork (80) to provide a convenient and practical way to rotate the knobs and adjust and switch the damping ratio.

The above and other objects, features and advantages of the present invention will become apparent from the following detailed description taken with the accompanying drawing.

With reference to FIGS. 1 to 7, the integral structure of the present invention, comprises the ON/OFF installing slot (32), the primary channel (33), the first and second secondary channels (341)(342), the first and second adjusting holes (41)(43) and the communication channel (50) as well as the position and space of each component, wherein the first, second and third secondary channels (341)(342)(343) are communicated with each other, and the first secondary channel (341) and the primary channel (33) are communicated with each other, and the ON/OFF installing slot (32) and the second secondary channel (342) are communicated with each other, and the third secondary channel (343) and the primary channel are arranged parallel to each other; the first adjusting hole (41) is coaxially installed at the top of the first secondary channel (341), and the second adjusting hole (43) is penetrated through the oil path separator seat (31); and the communication channel (50), the first and third secondary channels (341)(343), the ON/OFF installing slot (32) and the first and second adjusting holes (41)(43) are communicated with one another.

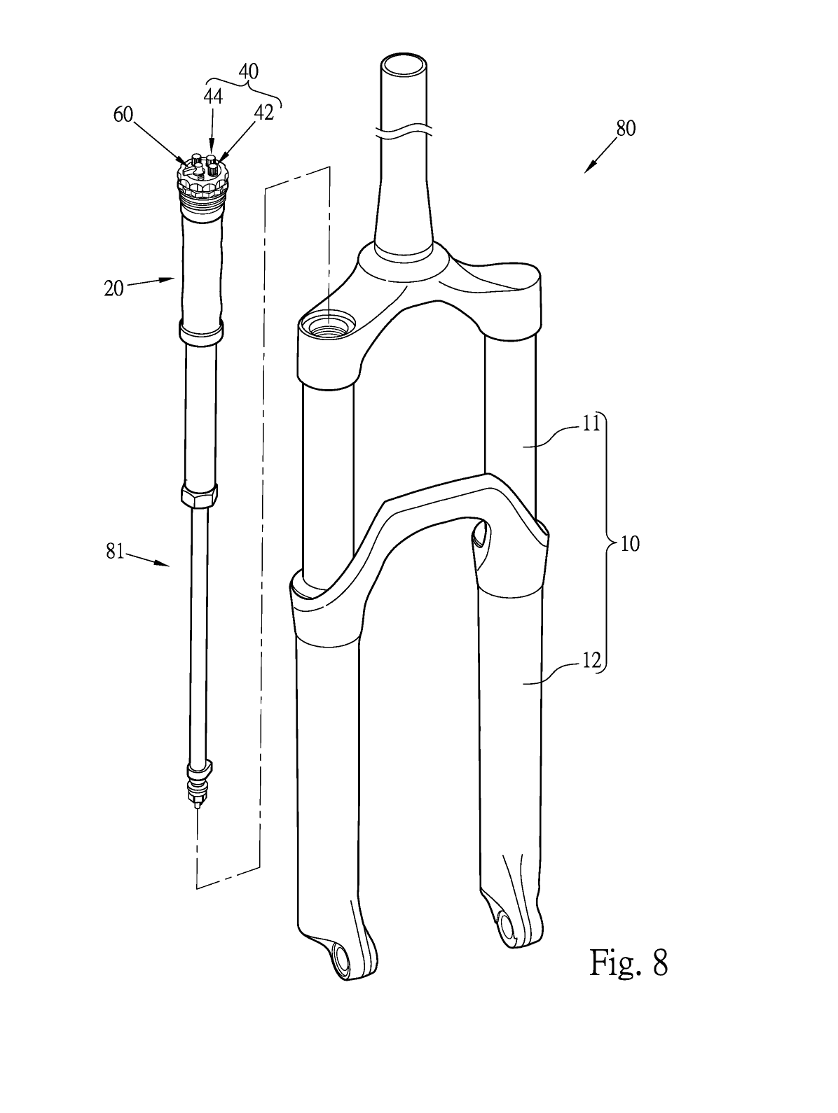

The present invention is applied and installed at the bicycle front fork (80). With reference to FIGS. 8 to 15, the oil path separator seat (31) is disposed at a shock absorption tube module (10) which comprises the inner tube (11) and the outer tube (12) sheathed on each other, and a front fork shock absorbing module (81) installed therein, and the base tube module (20) is installed at the top of the front fork shock absorbing module (81). When the present invention is installed, the second component (22) is fixed outside the first component (21), and then the switch seat (61) is installed into the ON/OFF installing slot (32), and the adjusting rods (421)(441) are passed into the first and second adjusting holes (41)(43) respectively, and the speed adjustment module (70) is installed in the mounting seat (35), and one of the steel balls (73)(74) is abutted and coupled to the adjusting rod (421)(441) or the sectioned portion (71)(72) of the switch seat (61), and the positioning tube (48) is used to sequentially pass the adjusting base (471), the regulating spring member (473), the first floating member (461), the reed (464), the second floating member (462) and the abutting member (45), so that an end of the positioning tube (48) is screwed and installed in the primary channel (33) under the oil path separator seat (31) and an edge of the adjusting rod (441) exposed from the bottom of the oil path separator seat (31) is abutted at and coupled to the abutting member (45), and then the oil path separator seat (31), the mounting seat (35), the switch seat (61) and the adjustment module (70) are installed in the first component (21), and the top cover (36) is installed onto the mounting seat (35). Now, an extended end of each of the adjusting rods (421)(441) and the switch seat (61) is exposed from the top cover (36), and each knob (423)(442) is installed between the top cover (36) and the mounting seat (35), and an end of each knob (423)(442) is passed and installed to the top cover (36) and exposed from the top cover (36), and the ON/OFF switch button (63) is installed to a distal end exposed form the switch seat (61), and finally a positioning ring (25) is used to fix the aforementioned components into the first component (21).

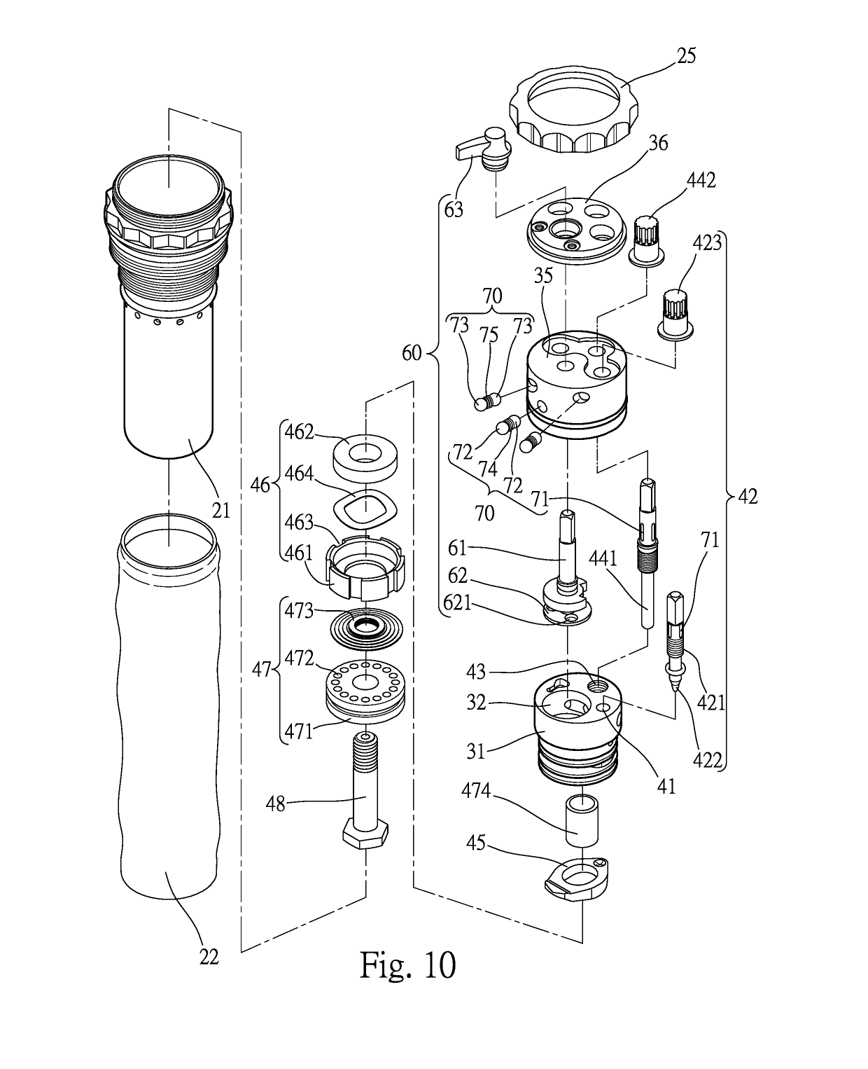

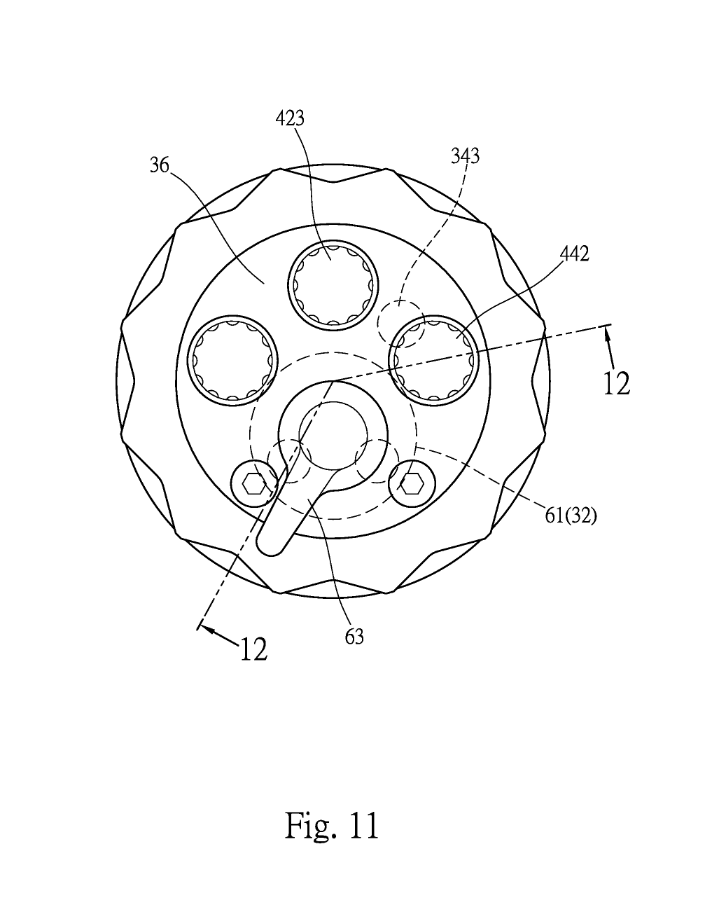

With reference to FIGS. 10 and 11 for the ON/OFF buffering status of the present invention, when the ON/OFF switch button (63) is switched to an ON status, the switch seat (61) is driven to rotate synchronously. Now, the hydraulic oil in the diversion hole (621) corresponsive to the second secondary channel (342), each of the primary oil chambers (23), the secondary oil chamber (24), and the oil path separation module (30) are in a flowing status, and the flowing takes place in two channels simultaneously.

The first channel is a path for circulating the hydraulic oil. With reference to FIGS. 11 to 13, the space in the first component (21) is compressed when an impact force is encountered, so that the hydraulic oil enters into the primary channel (33) from the primary oil chamber (23) and passes through the first secondary channel (341) and the communication channel (50) sequentially into the ON/OFF installing slot (32), and then passes through the diversion channel (62) and the diversion hole (621) of the switch seat (61) before flowing into the second secondary channel (342), and finally passes through the first component (21) and flows to the secondary oil chamber (24). When the impact force no longer exists, the space in the first component (21) resumes its original volume, hydraulic oil, and the hydraulic oil flows from the secondary oil chamber (24) to the second secondary channel (342) through the first component (21) and then passes through the diversion channel (62) and the diversion hole (621) of the switch seat (61) before exiting the ON/OFF installing slot (32) and entering into the communication channel (50), and the hydraulic oil further flows through the first secondary channel (341) and the primary channel (33), and finally returns to the primary oil chamber (23).

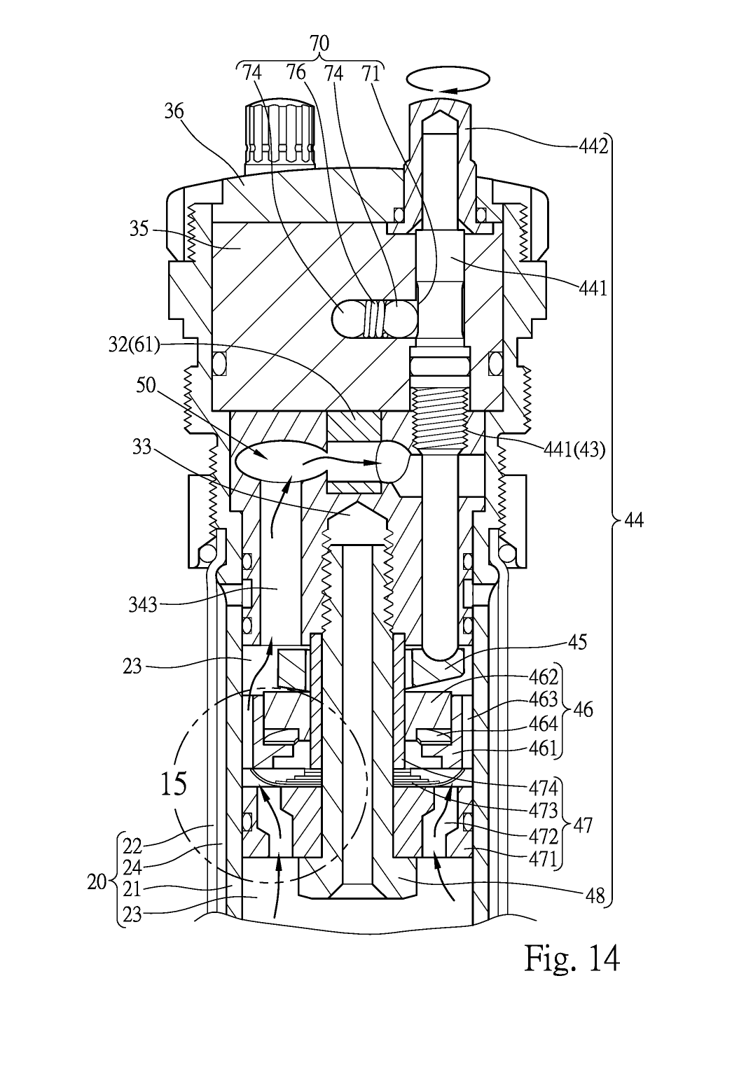

The second channel is also a path for circulating the hydraulic oil. With reference to FIGS. 14 to 17, the space in the first component (21) is compressed when an impact force is encountered, and the hydraulic oil enters into a penetrating hole (472) of the adjusting base (471) from the primary oil chamber (23), and sequentially passes through the adjusting spring (473) and the circulating portion (463) before entering into the third secondary channel (343), and further flows to the communication channel (50) and enters into the ON/OFF installing slot (32), and then passes through the diversion channel (62) and the diversion hole (621) of the switch seat (61) before flowing into the second secondary channel (342), and finally passes through the first component (21) and flows into the secondary oil chamber (24). When the impact force no longer exists, the space in the first component (21) resumes its original volume, and the hydraulic oil starts to return from the secondary oil chamber (24) and flows through the first component (21) to the second secondary channel (342), and passes through the diversion channel (62) and the diversion hole (621) of the switch seat (61) before exiting the ON/OFF installing slot (32) and entering into the communication channel (50), and the hydraulic oil sequentially passes through the third secondary channel (343), the circulating portion (463), the adjusting spring (473) and the penetrating hole (472) of the adjusting base (471), and finally returns into the primary oil chamber (23).

When the ON/OFF switch button (63) is rotated to the OFF status, the switch seat (61) is driven to rotate synchronously. Now, the diversion hole (621) is aligned alternately with the second secondary channel (342), and the hydraulic oil in each of the primary oil chambers (23), the secondary oil chamber (24) and the oil path separation module (30) are not situated in a flowing status, so that the buffering function is disabled.

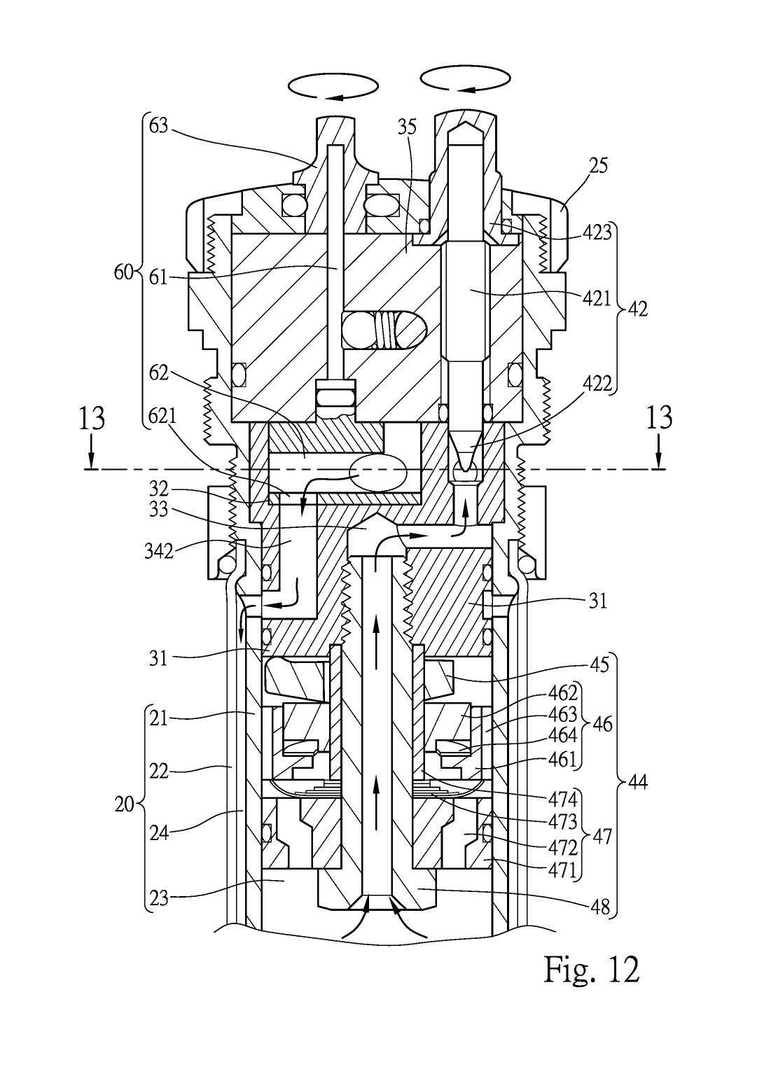

With reference to FIG. 12 for adjusting the damping ratio of the first adjustment module (42) of the present invention, when the knob (423) is rotated, the adjusting rod (421) is driven to produce a linear displacement synchronously. Now, the adjusting portion (422) occupies the channel space of the first adjusting hole (41), so as to change the flow rate of the hydraulic oil passing through this channel. When the space of the channel occupied by the adjusting portion (422) becomes greater the flow rate of the hydraulic oil becomes slower, and the damping ratio becomes greater, and the speed of compression and rebounce for the shock absorption becomes slower. When the space of the channel of the first adjusting hole (41) occupied by the adjusting portion (422) becomes smaller, the flow rate of the hydraulic oil becomes faster, and the damping ratio becomes smaller, and the speed of compression and rebounce of the shock absorption becomes faster.

With reference to FIGS. 14, 15, 18 and 19 for adjusting the damping ratio of the second adjustment module of the present invention, when the knob (442) is rotated, the adjusting rod (441) is driven to produce a linear displacement synchronously. Now, the bottom of the adjusting rod (441) is abutted and coupled to the abutting member (45) to synchronously press the floating component (46) in the floating status to produce a displacement. Now, a gap (d) exists between the first floating member (461) and the adjusting base (471), and the regulating spring member (473) is disposed in the space of the gap (d), so that the linear displacement of the adjusting rod (441) can change the gap (d).

When the gap (d) is relatively large, the hydraulic oil flows towards the secondary oil chamber (24) since the impact force produces a pressure, and the elastic regulating spring member (473) is pushed by the hydraulic oil and flipped outwardly to open the penetrating hole (472) of the adjusting base (471). After the regulating spring member (473) is flipped outwardly, the top of the regulating spring member (473) is limited by a distal surface of the first floating member (461) to change the extent of being flipped outwardly. When the extent of the regulating spring member (473) being flipped outwardly becomes smaller, the diameter of the penetrating hole (472) becomes smaller, and the flow rate of the hydraulic oil becomes slower, and the damping ratio becomes greater, and the speed of compression and rebounce for the shock absorption becomes slower. When the extent of the regulating spring member (473) being flipped outwardly becomes greater, the diameter of the penetrating hole (472) becomes greater, and the flow rate of the hydraulic oil becomes faster, and the damping ratio becomes smaller, and the speed of compression and rebounce for the shock absorption becomes faster.

In the present invention, the oil path separator seat (31) provides two channels including the primary channel (33) and the third secondary channel (343) for the circulation of the hydraulic oil. When a large impact force is encountered, the second channel is a channel provided for the circulation, while offering a lower numerical range of the damping ratio of the shock absorber. In other words, the greater the flow, the faster the flow rate. Therefore, the speed of compression and rebounce for the shock absorption is fast. On the other hand, the present invention applies the oil path separator seat (31) to provide a bypass flow structure between the primary oil chamber (23) and the secondary oil chamber (24), so as to offer a higher numerical range of the damping ratio of the shock absorber. In other words, the smaller the flow, the smaller the flow rate. Therefore, the speed of compression and rebounce for shock absorption is slow. Overall speaking, the setting range of the damping ratio of the present invention is greater than that of the conventional structure, and the invention has the effect of increasing the numerical range of the damping ratio.

Since the present invention has a greater numerical range of the damping ratio and integrates a plurality of channels to diversify the internal liquid pressure and impact force of the hydraulic oil, so that when an impact force is encountered, the invention has the effects of lowering the chance of colliding or damaging related components, extending the service life of components, reducing the compression and rebounce of the shock absorption caused by the high damping ratio, preventing riders from losing their balance caused by a large position differentiation of compression and rebounce during the shock absorbing process, and improving the safety of riding effectively.

The present invention provides the oil path separator seat (31) for separating the paths of the hydraulic oil appropriately and includes the primary channel (33) and secondary channel group (34) to flow the hydraulic oil to each of the primary oil chambers (23) or the secondary oil chamber (24) according to a predetermined setting and also the effects of integrating the hydraulic oil and dividing the hydraulic oil. On the other hand, the oil path separator seat (31) is not just applied to the structure having each of the primary oil chambers (23) and the secondary oil chamber (24) configured to be perpendicular to each other only, but it is also applied to the structure having each of the primary oil chambers (23) and the secondary oil chamber (24) configured to be parallel to each other as well.

In the present invention, the oil path separator seat (31) is adopted to provide a better bypass flow structure between each of the primary oil chambers (23) and the secondary oil chamber (24) and integrates the structural design of the adjustment module (40). Further, the knob (423)(442) and the switch seat (61) are installed at the top of the bicycle front fork, so that a rider just needs to stop the bike and sit on the bike frame to adjust the damping ratio by bending down slightly and rotating the knobs (423)(442) and the switch seat (61) by hands before starting the ride again. The present invention provides a convenience application, even when the rider needs to rotate the knobs to make adjustment and ride repeatedly. The operations of enabling/disabling the shock absorption and adjusting the damping ratio in accordance with the present invention are user-friendly, and overcome the inconvenience of the conventional way of making the adjustment that requires the rider to leave the bike frame and squat down to make the adjustment.

The adjustment module (40) of the present invention usually comes with a design having a plurality of regulating mechanisms, and different positions and channels of the related components installed in the first and second adjustment modules (42)(44) are used to provide different damping effects, so that the numerical range of adjusting the damping ratio is more precise to provide a more sensitive buffering adjustment to meet the requirements of professional riders.

The floating component (46) of the present invention is a two-piece component including the first and second floating members (461)(462), and the first and second floating member(461)(462) are coupled by the reed (463), so that the floating component (46) can float in the oil chamber and displace linearly, while providing a compressed space and an elastic force to reduce or eliminate the internal liquid pressure of the hydraulic oil effectively and providing a second buffering function.

In the present invention, the adjustment module (47) includes a regulating reed (473) installed between the first floating member (461) and the adjusting base (471) and mainly used for covering the penetrating holes (472) effectively, and the diameter of the penetrating holes (472) varies, so that the amount and flow rate of the hydraulic oil vary as well. The regulating reed (473) has an elastic restoring force, so that when the liquid pressure and the impact force of the hydraulic oil no longer exist, the regulating reed (473) automatically resume its original shape to cover each of the penetrating holes (472) completely, so that the second oil path is not in a flowing status. When a large impact force is exerted onto the second adjustment module (44) of the present invention, the bypass channel is opened, so as to achieve the effect of bypassing the hydraulic oil quickly and dividing the impact pressure effectively.

In the speed adjustment module (70) of the present invention, each of the steel balls (73)(74) is attached and installed onto each of the adjusting rods (421)(441) and the switch seat (61), and each of the sectioned portions (71)(72) is in a planar shape, and the elastic force of the elastic member (75)(76) is provided for compressing and restoring the steel balls (73)(74) to their original positions, so that when each of the adjusting rods (421)(441) and the switch seat (61) is rotated, a click sound and/or a slight vibration is produced to achieve the effect of making adjustments at different levels.

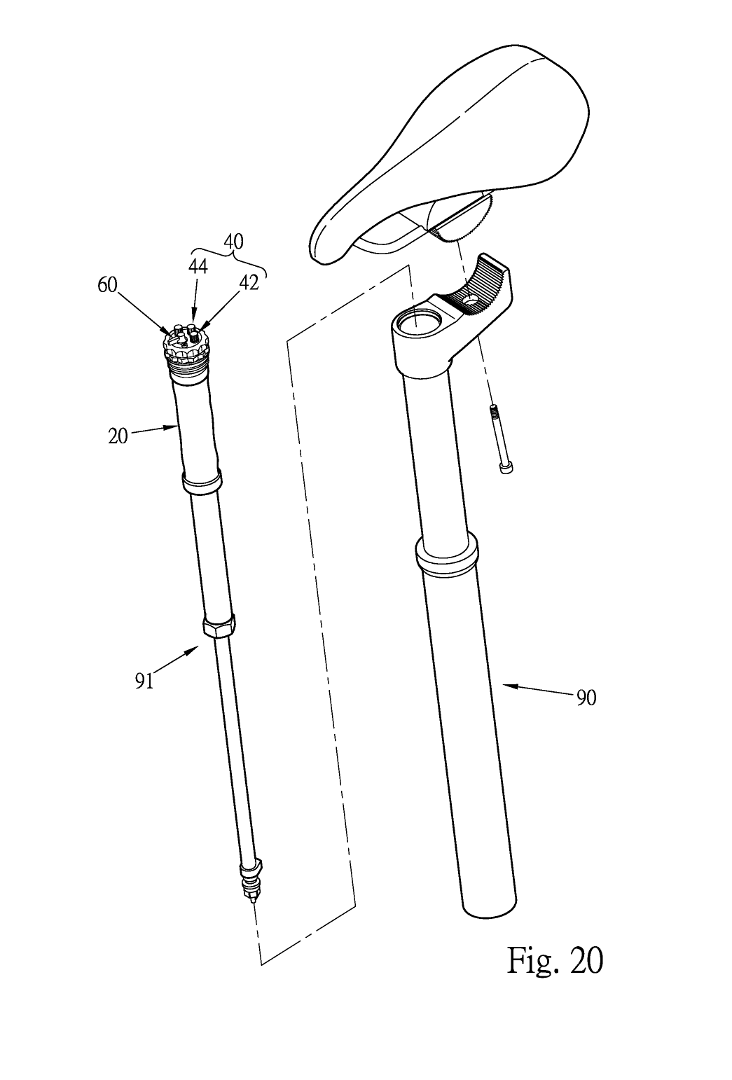

With reference to FIG. 20 for another preferred embodiment of the present invention, this embodiment is an implementation mode applied in a seat post (90) of a bicycle, wherein the seat post is the shock absorption tube module (10) of the present invention and comprises an inner tube (11) and an outer tube (12) sheathed and linearly contracted and extended with respective to each other, a seat post shock absorbing module (91) installed in the shock absorption tube module (10), a base tube module (20) installed at the top of the shock absorbing module (91) of the seat post (90), and components including an oil path separation module (30), an adjustment module (40), a communication channel (50), an ON/OFF switch module (60) and level adjustment module (70) installed in the base tube module (20).

The installation, oil path, and operating status of this preferred embodiment are the same as those of the previous preferred embodiment. The present invention may be applied to a front fork and a seat post of a bicycle, or a shock absorbing system of a motorcycle or a motor vehicle, or various machines or devices to achieve the foregoing expected effects.

In summation of the description above, the flow adjustment and oil path separation structure of a shock absorber in accordance with the present invention provides a shock absorber with better sensitivity, higher precision of adjusting the damping ratio, and greater numerical range of damping ratio, and the invention comes with an oil path separator seat with a bypass flow path structure and a design of two channels for bypassing the hydraulic oil and dividing the pressure, so that users may adjust the amount and flow rate of the hydraulic oil to achieve the effects of lowering the chance of colliding and damaging the components, reducing the compression and rebounce for the shock absorption, improving the safety of riding, and providing a convenient way for the riders to adjust and switch the knob by designing the knob at the top of the front fork. Therefore, the invention provides a highly compatible and practical shock absorbing structure.

What is claimed is:

1. An oil path separation structure of a shock absorber, comprising:
an oil path separator seat being substantially in the shape of a seat;
an ON/OFF installing slot being a groove formed at a predetermined position of the oil path separator seat for providing a position for installing an ON/OFF switch module;
a primary channel disposed at a predetermined position in the oil path separator seat, and communicating with a primary oil chamber;
a secondary channel group disposed at a predetermined position of the oil path separator seat, and having a first secondary channel and a second secondary channel, the first secondary channel having an end communicating with the primary channel and the other end communicating with a secondary oil chamber, the second secondary channel having an end communicating with the ON/OFF installing slot and the other end communicating with the secondary oil chamber;
an adjustment module having a first adjusting hole for providing a position for installing a first adjustment module, the first adjusting hole having an end communicating with the secondary channel group;
a communication channel disposed at a predetermined position in the oil path separator seat and communicating with each of the first secondary channels and the ON/OFF installing slot.

2. A flow adjustment structure of a shock absorber, comprising:
a shock absorption tube module having an inner tube and an outer tube in form of a telescope, and linearly contractible and extendable with respect to each other;
a base tube module installed at a predetermined position in the inner tube, and having a first component and a second component sheathed on one another, the first component having a primary oil chamber formed therein, and a secondary oil chamber formed between the first and second components;
an oil path separation module having an oil path separator seat, an ON/OFF installing slot concavely formed at a predetermined position and communicating with the secondary oil chamber, the oil path separator seat having a primary channel communicating with the primary oil chamber, a secondary channel group communicating with the secondary oil chamber, an end of the secondary channel communicating with the primary channel;
an adjustment module having a first adjusting hole, an end communicating with the secondary channel group, a communication channel communicating with each of the ON/OFF installing slot and secondary channel group, a first adjustment module installed in the first adjusting hole for adjusting the amount of hydraulic oil following in the first adjusting hole, and
an ON/OFF switch module installed in the ON/OFF installing slot for switching flow ON/OFF status of the secondary channel group, such that when the ON/OFF switch module is switched ON, each of the primary channel and the secondary channel group is situated in a shock absorbing status, when there is an impact pressure, the hydraulic oil flows from the primary oil chamber through the primary channel and sequentially passes through the secondary channel group and the communication channel, and enters into the ON/OFF installing module before flowing to the secondary oil chamber, so as to define a shock absorbing and buffering status.

3. The flow adjustment structure of a shock absorber according to claim 2, wherein the secondary channel group includes a first secondary channel and at least one second secondary channel, the first secondary channel has an end communicating with the primary channel and the other end communicating with a secondary oil chamber, the second secondary channel has an end communicating with the ON/OFF installing slot and the other end communicating with the secondary oil chamber, the communication channel communicates with each of the first secondary channel and ON/OFF installing slot at the same time.

4. The oil path separation structure of a shock absorber according to claim 1, wherein the secondary channel group includes a third secondary channel defined in the oil path separator seat, the third secondary channel has an end communicating with the communication channel and the other end communicating with the primary oil chamber, and the communication channel is communicated with each of the first secondary channel, the ON/OFF installing slot, the third secondary channel, and the second adjusting hole at the same time.

5. The oil path separation structure of a shock absorber according to claim 1, wherein the adjustment module has a second adjusting hole which is a penetrating hole formed in the oil path separator seat for providing a position for installing a second adjustment module, the second adjusting hole has an end communicating with the primary oil chamber, the second adjustment module adjusts the amount of hydraulic oil in the second adjusting hole.

6. The oil path separation structure of a shock absorber according to claim 1, wherein the adjustment module has a second adjusting hole which is a penetrating hole formed in the oil path separator seat for providing a position for installing a second adjustment module, the oil path separation module has a mounting seat installed at the oil path separator seat for providing a position for installing each of the ON/OFF switch module and the first and second adjustment modules therein, the oil path separation module has a top cover installed to the top of the mounting seat for providing a position for installing each of the ON/OFF switch module and the first and second adjustment modules partially therein and exposed partially therefrom.

7. The oil path separation structure of a shock absorber according to claim 1, wherein the first adjustment module includes an adjusting rod with an end disposed in the oil path separator seat, which is a flow path of the hydraulic oil between each of the secondary channels and the communication channel, the other end of the adjusting rod is extended to the exterior of the oil path separator seat, the adjusting rod is linearly displaceable in the oil path separator seat, the adjusting rod has an adjusting portion in a shape of a cone and formed at an end of the flow path of the hydraulic oil, a knob is installed at the adjusting rod exposed from the oil path separator seat for driving the adjusting rod to rotate synchronously, while driving the adjusting rod to displace linearly in the oil path separator seat, an amount and flow rate of the flow path of the hydraulic oil flowing between each of the secondary channels and the communication channel is adjusted by a change of positions of the adjusting portion of the adjusting rod.

8. The oil path separation structure of a shock absorber according to claim 1, wherein the adjustment module has a second adjusting hole which is a penetrating hole formed at the oil path separator seat for providing a position of installing a second adjustment module, the second adjustment module has an adjusting rod which passes through the second adjusting hole and has an end extended into the primary oil chamber and is coupled to an abutting member, the second adjustment module has a floating component and an adjustment module installed in the primary oil chamber, the adjustment module is provided for circulating a hydraulic oil and has a positioning tube to sequentially pass and install the adjustment module, the floating component and the abutting member so as to install and position the adjustment module to the oil path separator seat, the floating component in the primary oil chamber is situated in a linearly moving status, the adjusting rod and the abutting member synchronously and linearly move with each other to abut the floating component for a synchronous displacement, so as to adjust a distance between the floating component and the adjustment module, and to adjust a amount and flow rate of the hydraulic oil in the primary oil chamber that passes through the adjustment module.

9. The oil path separation structure of a shock absorber according to claim 8, wherein the adjustment module comprises an adjusting base which has a plurality of penetrating holes formed therein for circulating the hydraulic oil, a regulating spring member is installed onto the adjusting base to open or close each of the penetrating holes, and to adjust a distance between the regulating spring member and the penetrating holes according to the pressure of the hydraulic oil, an abutting ring is in a shape of a circular base and installed to outside the positioning tube, the abutting ring has an end abutted and positioned at the oil path separator seat, and the other side is abutted and coupled to a central position of the regulating spring member.

10. The oil path separation structure of a shock absorber according to claim 8, wherein the floating component comprises a first floating member and a second floating member coupled to each other, the first floating member abuts against the abutting member, the second floating member is installed to outside the first floating member and has a plurality of circulating portions for circulating the hydraulic oil, a reed is installed between the first and second floating members for providing a compressible elastic space between the first and second floating members.

11. The oil path separation structure of a shock absorber according to claim 5, wherein the oil path separation module comprises a mounting seat which is installed at the top of the oil path separator seat for providing a position for installing each of the ON/OFF switch module and the first and second adjustment modules therein, each of the first and second adjustment modules has a speed adjustment module installed in the mounting seat and abuts against the adjust rod along the radial direction of the adjusting rod, the speed adjustment module has at least one sectioned portion in a planar shape and disposed around the adjusting rod, and the speed adjustment module comprises at least one steel ball and an elastic member coupled to each other and installed in the mounting seat, the steel ball is effectively coupled and abutted against the sectioned portion.

12. The oil path separation structure of a shock absorber according to claim 2, wherein the secondary channel group includes a third secondary channel defined in the oil path separator seat, the third secondary channel has an end communicating with the communication channel and the other end communicating with the primary oil chamber, and the communication channel is communicated with each of the first secondary channel, the ON/OFF installing slot, the third secondary channel, and the second adjusting hole at the same time.

13. The oil path separation structure of a shock absorber according to claim 2, wherein the adjustment module has a second adjusting hole which is a penetrating hole formed in the oil path separator seat for providing a position for installing a second adjustment module, the second adjusting hole has an end communicating with the primary oil chamber, the second adjustment module adjusts the amount of hydraulic oil in the second adjusting hole.

14. The oil path separation structure of a shock absorber according to claim 2, wherein the adjustment module has a second adjusting hole which is a penetrating hole formed in the oil path separator seat for providing a position for installing a second adjustment module, the oil path separation module has a mounting seat installed at the oil path separator seat for providing a position for installing each of the ON/OFF switch module and the first and second adjustment modules therein, the oil path separation module has a top cover installed to the top of the mounting seat for providing a position for installing each of the ON/OFF switch module and the first and second adjustment modules partially therein and exposed partially therefrom.

15. The oil path separation structure of a shock absorber according to claim 2, wherein the first adjustment module includes an adjusting rod with an end disposed in the oil path separator seat, which is a flow path of the hydraulic oil between each of the secondary channels and the communication channel, the other end of the adjusting rod is extended to the exterior of the oil path separator seat, the adjusting rod is linearly displaceable in the oil path separator seat, the adjusting rod has an adjusting portion in a shape of a cone and formed at an end of the flow path of the hydraulic oil, a knob is installed at the adjusting rod exposed from the oil path separator seat for driving the adjusting rod to rotate synchronously, while driving the adjusting rod to displace linearly in the oil path separator seat, an amount and flow rate of the flow path of the hydraulic oil flowing between each of the secondary channels and the communication channel is adjusted by a change of positions of the adjusting portion of the adjusting rod.

16. The oil path separation structure of a shock absorber according to claim 2, wherein the adjustment module has a second adjusting hole which is a penetrating hole formed at the oil path separator seat for providing a position of installing a second adjustment module, the second adjustment module has an adjusting rod which passes through the second adjusting hole and has an end extended into the primary oil chamber and is coupled to an abutting member, the second adjustment module has a floating component and an adjustment module installed in the primary oil chamber, the adjustment module is provided for circulating a hydraulic oil and has a positioning tube to sequentially pass and install the adjustment module, the floating component and the abutting member so as to install and position the adjustment module to the oil path separator seat, the floating component in the primary oil chamber is situated in a linearly moving status, the adjusting rod and the abutting member synchronously and linearly move with each other to abut the floating component for a synchronous displacement, so as to adjust a distance between the floating component and the adjustment module, and to adjust a amount and flow rate of the hydraulic oil in the primary oil chamber that passes through the adjustment module.

17. The oil path separation structure of a shock absorber according to claim 16, wherein the adjustment module comprises an adjusting base which has a plurality of penetrating holes formed therein for circulating the hydraulic oil, a regulating spring member is installed onto the adjusting base to open or close each of the penetrating holes, and to adjust a distance between the regulating spring member and the penetrating holes according to the pressure of the hydraulic oil, an abutting ring is in a shape of a circular base and installed to outside the positioning tube, the abutting ring has an end abutted and positioned at the oil path separator seat, and the other side is abutted and coupled to a central position of the regulating spring member.

18. The oil path separation structure of a shock absorber according to claim 16, wherein the floating component comprises a first floating member and a second floating member coupled to each other, the first floating member abuts against the abutting member, the second floating member is installed to outside the first floating member and has a plurality of circulating portions for circulating the hydraulic oil, a reed is installed between the first and second floating members for providing a compressible elastic space between the first and second floating members.

19. The oil path separation structure of a shock absorber according to claim 13, wherein the oil path separation module comprises a mounting seat which is installed at the top of the oil path separator seat for providing a position for installing each of the ON/OFF switch module and the first and second adjustment modules therein, each of the first and second adjustment modules has a speed adjustment module installed in the mounting seat and abuts against the adjust rod along the radial direction of the adjusting rod, the speed adjustment module has at least one sectioned portion in a planar shape and disposed around the adjusting rod, and the speed adjustment module comprises at least one steel ball and an elastic member coupled to each other and installed in the mounting seat, the steel ball is effectively coupled and abutted against the sectioned portion.
